(19) United States
(12) Patent Application Publication
(10) Pub. No.: US 2011/0162529 A1
(43) Pub. Date: Jul. 7, 2011

(54) Kitchenware Device for Preparing Hot Beverages or for Cooking

(75) Inventors: Giacomo Alberganti, Brescia (IT); Daniele Marioli, Brescia (IT); Vittorio Ferrari, Brescia (IT)

(73) Assignee: BIALETTI INDUSTRIE S.P.A., Coccaglio, Brescia (IT)

(21) Appl. No.: 12/989,252

(22) PCT Filed: Jun. 3, 2008
(86) PCT No.: PCT/IT2008/000366

§ 371 Date: Jan. 10, 2011

(51) Int. Cl. A47J 31/10; B65D 45/00

(52) U.S. Cl. 99/279; 220/212; 220/315

(57) ABSTRACT

The present invention relates to a cover (1) of a coffee pot (20) or a pot (60) comprising conversion means (8) suitable for converting a thermal gradient, such as a Peltier cell, into an electrical potential difference. The potential difference allows electrically supplying a microprocessor for processing a signal coming from a sensor (13), for example a thermal sensor and the execution of an operation thereof, such as the emission of a sound warning.

The object of the present invention is a kitchenware device for preparing hot beverages, for example a coffee pot and similar, or for cooking, such as a pot, a pan and similar, suitable for being placed on a cooking top, for example a gas, electrical or induction top, provided with an electric energy generator.

Such devices have recently had a considerable development, as they allow providing, in combination with the generator, some accessories with electrical operation, for example for measuring the cooking temperature.

For example, some solutions envisage the use of batteries onboard of the device, for the electrical supply of accessories, such as displays, thermometers and the like.

However, such devices have several disadvantages, such as the fact of requiring the replacement of exhausted batteries (and thus seeing to the disposal thereof), fragility of the device in the washing, and many others.

Further solutions envisage the use of a thermocouple or Peltier cell for converting a thermal gradient into electrical energy. For example, such solution is described in document EP-A1-1745729.

However, also such solutions have some disadvantages, such as the too low level of potential difference provided by the cell, which strongly limits the range if usable accessories.

The object of the present invention is to provide a kitchenware device for preparing hot beverages, for example a coffee pot and similar, or for cooking, such as a pot, a pan and similar, suitable for being placed on a cooking top, for example a gas, electrical or induction top, provided with a converter for converting a thermal gradient into electric energy, which should overcome the disadvantages mentioned with reference to the prior art and meet the above requirements.

Such object is achieved by a kitchenware device obtained according to claim 1. The dependent claims describe embodiment variations.

The features and advantages of the kitchenware device according to the present invention will appear more clearly from the following description, made by way of an indicative and non-limiting example with reference to the annexed figures, wherein:

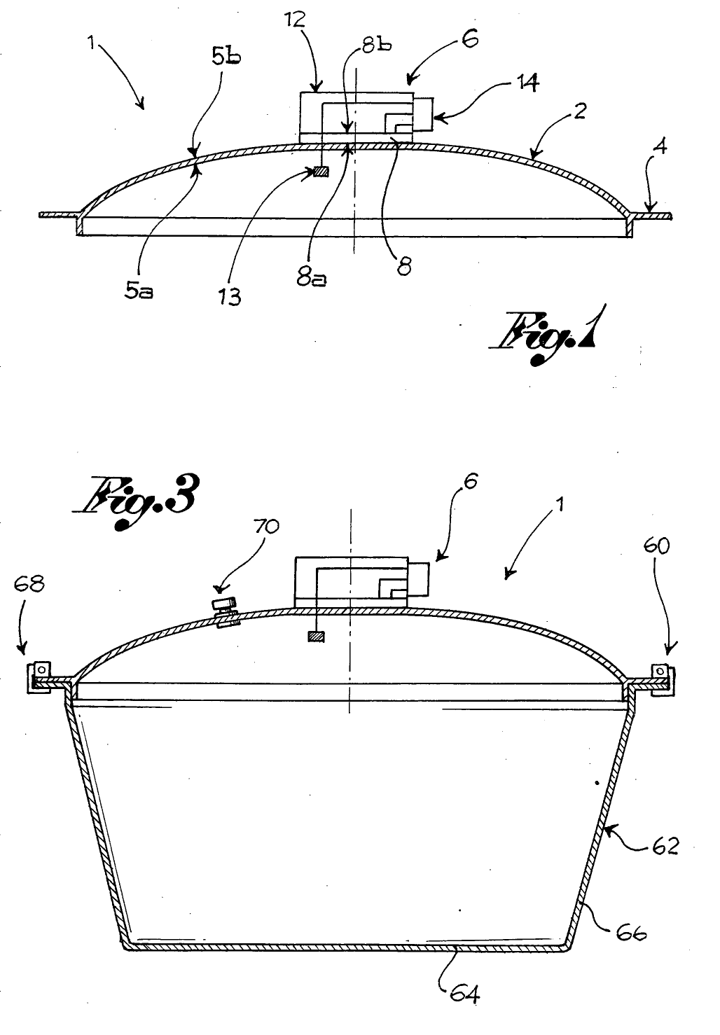

FIG. 1 shows a diagram of a cover of a kitchenware device according to the present invention, in accordance with an embodiment variation;

FIG. 2 shows a diagram of a coffee pot according to the present invention;

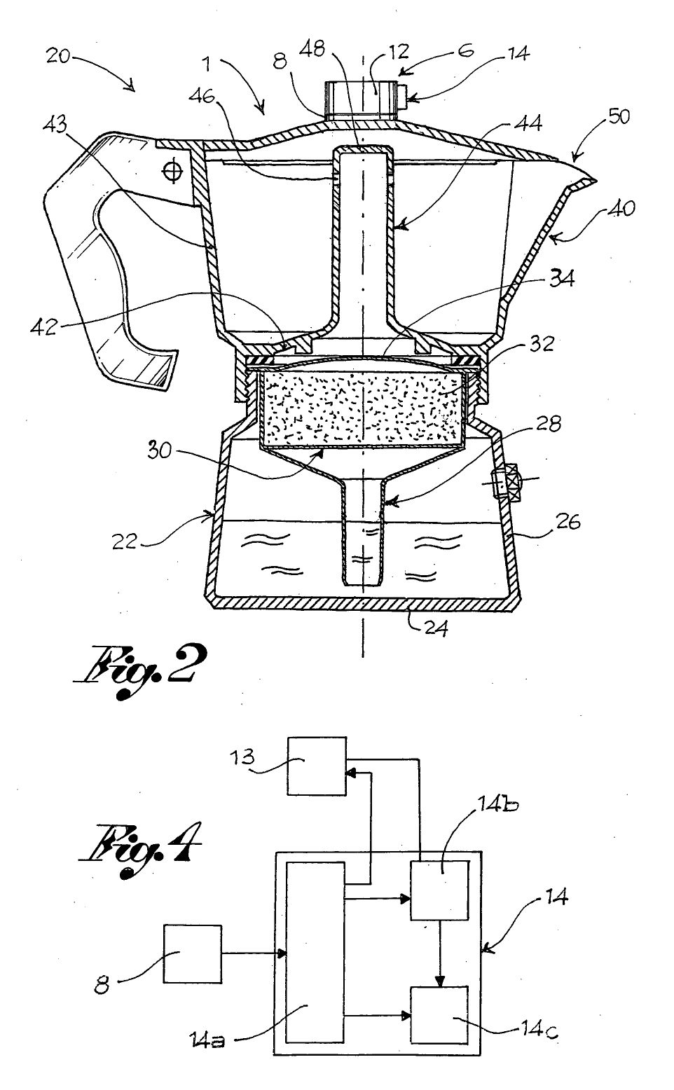

FIG. 3 shows a diagram of a pot according to the present invention; and

FIG. 4 shows a diagram of a treatment unit according to the present invention, in accordance with an embodiment variation.

According to the annexed figures, reference numeral 1 globally denotes a cover for a kitchenware device.

For example, the kitchenware device comprises a container that has an opening for accessing the inside space.

Cover 1 comprises a body 2, for example shaped as a cap, having a peripheral edge 4 for resting on the edge that delimits the opening of the container.

The body consists of a wall that has an inside surface 5a, intended to be facing inwards of the container when the cover is associated thereto, and an opposite outside surface 5b.

For example, the inside surface corresponds to the concave surface of the wall.

According to a preferred embodiment, cover 1 comprises hinging means suitable for hinging body 2 to the container, for lowering or lifting the cover and allowing access to the inside space.

Cover 1 comprises a conversion and treatment device 6 suitable for generating a potential difference and for conveniently treating the generated potential difference.

The conversion and treatment device 6 comprises conversion means suitable for converting a thermal gradient into a potential difference. For example, the conversion means comprise at least one Peltier cell 8, operating by Seebeck effect, which provides a potential difference to the ends of a connection when the cell is immersed in a thermal gradient.

In particular, the plate shaped cell 8 has an inside face 8a and an outside face 8b: the inside face rests on body 2 of cover 1, for example on a flat portion thereof.

According to a preferred embodiment, the cell is arranged in central position on body 2 of cover 1, for example in a symmetrical position relative to the body axis.

Moreover, the conversion and treatment device 6 comprises a dissipator 12 associated to the conversion means, suitable for dissipating the heat to the exterior.

For example, dissipator 12 comprises an element, for example solid, of a thermal conductor material, for example aluminium, steel or copper.

Preferably, dissipator 12 surmounts the Peltier cell 8, that is, rests on the outside face 8b thereof, for improving the achievement of a thermal gradient between the inside face 8a and the outside face 8b.

According to a preferred embodiment, the kitchenware device comprises a sensor 13 suitable for sensing a physical parameter, for example suitable for sensing the temperature.

Preferably, sensor 13 protrudes from body 2 of cover 1 to be arranged inside the kitchenware device in the routine use.

Moreover, the conversion and treatment device 6 comprises a treatment unit 14, operatively connected to the conversion means, suitable for treating the potential difference provided by the conversion means.

Preferably, the treatment unit 14 is operatively connected to sensor 13 for acquiring the signal thereof.

For example, the treatment unit 14 comprises:

a conditioning unit 14a, connected to the conversion means, for conditioning the potential difference provided by said conversion means;

a microprocessor 14b or other processing unit, connected to the conditioning unit 14a for the electrical supply thereof and to sensor 13, for processing the signal coming from said sensor;

a functional unit 14c, connected to microprocessor 14b, such as a sound emitter or a radio wave transmitter.

Preferably, the conditioning unit 14a is connected to sensor 13 and/or to the functional unit 14c for the electrical supply of said components.

According to a preferred embodiment, the treatment unit 14 is supported by dissipator 12, for example laterally thereto, so as to not hinder the heat dissipation.

Advantageously, the conversion and treatment device allows using the temperature gradient the cover is subject to, at the best.

Moreover, advantageously, the heat is eliminated directionally by the dissipator, for enhancing the thermal gradient.

In accordance with a preferred embodiment, the kitchenware device is as coffee pot 20 (FIG. 2).

Coffee pot 20 comprises a boiler 22 for containing water intended for preparing coffee and suitable for being placed on a stove top for heating water.

Boiler 22 comprises a bottom 24, intended for contacting the stove top, and an annular side wall 26, protruding from bottom 24, with which it is jointed.

The side wall 26 has a converging profile from bottom 24 towards the top portion.

The coffee pot 20 further comprises a funnel 28 with perforated intermediate plate 30 for making a powder seat 32, intended for receiving powder coffee.

Coffee pot 20 further comprises a perforated filter plate 34.

Funnel 28 is inserted in the boiler and is surmounted by the filter plate 34.

Coffee pot 20 further comprises a container 40, which surmounts boiler 22, for example fixed thereto by screwing.

Container 40 comprises a bottom 42 and an annular side wall 43, jointed to the bottom and peripherally projecting therefrom.

Container 40 further comprises a stack 44 projecting from bottom 42 and provided with at least one opening 46, for example at the top, for the outlet of the coffee.

Preferably, stack 44 has a screening wall 48 at the top free end, whereunder said opening 46 open.

Preferably, sensor 13 surmounts stack 44 or it is arranged downstream of openings 46 thereof.

Moreover, the coffee pot comprises cover 1, hinged to side wall 43.

Side wall 43 is open in a zone of the edge for forming an outlet 50 for pouring the coffee.

Preferably, moreover, the side wall has a diverging shape, that is, that enlarges, from the bottom towards the top portion.

Cover 1 comprises the conversion and treatment device 6, comprising the conversion means 8, dissipator 12 and the treatment unit 14.

In the configuration with closed cover, the conversion means 8 surmount the stack 44, in symmetrical position.

Advantageously, the arrangement of the conversion and treatment device allows using the Seebeck effect whereon the operation of cell 8 is based at the best, preventing the peripheral edge of the cell from being impinged by an excessive amount of heat, which would affect the optimum operation thereof.

In particular, the configuration of the coffee pot that has a converging boiler and a diverging container, further improves the cell performance.

According to an operating example, by virtue of the thermal gradient that is obtained when the coffee pot is subject to a heat source, the Peltier cell 8 generates a potential difference that after the conditioning by the conditioning unit 14a, electrically feeds sensor 13, microprocessor 14b and, for example, the sound emitter 14c.

Sensor 13 senses the temperature inside container 40 of the coffee pot, preferably at openings 46 of stack 44, and transmits the temperature signal to the treatment unit.

The temperature signal is acquired by microprocessor 14b which, when the signal meets a requirement, for example corresponding to the condition of “coffee ready”, for example when a reference temperature is reached or when the time pattern of the temperature is constant in a predetermined time interval, sends a signal to the functional unit 14c, for example for emitting a sound.

In accordance with a further embodiment, the kitchenware device is a pot 60 comprising a container 62, provided with a bottom 64 and a side wall 66, and cover 1 provided with the conversion and treatment device 6.

For example, pot 60 is of the “pressure” type, that is, cover 1 or container 62 are provided with mechanical means 68 for retaining the cover to the container and means 70 for releasing the vapour generated into the container during the cooking.

Innovatively, the kitchenware device according to the present invention allows overcoming the disadvantages of the prior art and in particular, it allows converting a thermal gradient in a difference of electrical potential, using the conditions of the device at the best.

It is clear that a man skilled in the art could make changes to the device described above in order to meet specific and incidental needs, all falling within the scope of protection defined in the following claims.

1. A cover of a kitchenware device, such as a coffee pot, a pot and similar, comprising:
conversion means suitable for converting a thermal gradient into an electrical potential difference.

2. Cover according to claim 1, wherein the conversion means comprise a Peltier cell.

3. Cover according to claim 2,
wherein the cover comprises a body provided with a peripheral edge for resting on the edge that delimits the opening of a container of the kitchenware device, the body having an inside surface facing inwards of the container, and an outer surface facing outwards;
and wherein the Peltier cell has an inside face resting on the body of the cover, externally.

4. Cover according to claim 3, comprising a dissipator that surmounts the Peltier cell, in contact with the outside face thereof.

5. Cover according to claim 1, comprising a sensor for sensing a physical parameter, for example for sensing the temperature.

6. Cover according to claim 5, comprising a treatment unit connected to the conversion means and to the sensor, suitable for treating the signal coming from the sensor.

7. Cover according to claim 6, wherein the treatment unit comprises:
a conditioning unit, connected to the conversion means, for conditioning the potential difference provided by the conversion means;
a microprocessor or other processing unit, connected to the conditioning unit for the electrical supply thereof and to sensor, for processing the signal coming from the sensor;
a functional unit, connected to the microprocessor, such as a sound emitter or a radio wave transmitter.

8. Cover according to claim 7, wherein the conditioning unit is connected to the sensor and/or to the functional unit for the electrical supply of the components.

9. Cover according to claim 7, wherein the treatment unit is supported by the dissipator, laterally.

10. Coffee pot comprising:
a boiler for containing and heating water;
a powder seat for containing powder coffee, which surmounts the boiler;
a container which surmounts the boiler;
a cover, associated to the container, wherein the cover comprises conversion means suitable for converting a thermal gradient into an electrical potential difference.

11. Coffee pot according to claim 11, wherein the container comprises:
a bottom for the connection to the boiler;
an annular side wall projecting from the bottom and jointed thereto; and
a stack projecting from the bottom inwards of the container, provided with openings for the outlet of the coffee into the container; and wherein, as the cover is closed, the conversion means surmount the stack top.

12. Coffee pot according to claim 10, wherein the cover is hinged to the container.

13. Coffee pot according to claim 10, wherein the boiler has a profile converging from the bottom towards the top and the container a diverging profile from the bottom towards the top.

14. Coffee pot according to claim 10, wherein the sensor is arranged so as to surmount the stack or downstream of the openings thereof.

15. Pot comprising:
a container;
a cover comprising conversion means suitable for converting a thermal gradient into an electrical potential difference.

16. Pot according to claim 15, of the “pressure” type, comprising mechanical means for retaining the cover in the closed configuration to the container.
